(19) United States
(12) Patent Application Publication
(10) Pub. No.: US 2006/0114685 A1
(43) Pub. Date: Jun. 1, 2006

(54) Vehicle-mounted illuminated display

(76) Inventor: Patrick Seeber, Sparks, NV (US)

Correspondence Address: LANGLOTZ PATENT WORKS, INC., PO BOX 759, GENOA, NV, 89411, US

(21) Appl. No.: 11/001,964

(22) Filed: Nov. 30, 2004

(51) Int. Cl. B60Q 1/32

(52) U.S. Cl. 362/495

(57) ABSTRACT

A vehicle light for connection beneath a doorway of the vehicle. The light has an elongated housing element with an aperture facing laterally away from the vehicle. A light source is contained within the housing. A light-transmissive image element is removably connected to the housing to overlay the aperture. The housing may be tubular, with a circular cross section, and the light source may be a linear element centered in the tube. The light source may be a broad band emitter, so that a multicolor image element may be illuminated.

### FIELD OF THE INVENTION

The invention relates to decorative vehicle lighting, and more particularly to step bars for trucks and other vehicles.

### BACKGROUND OF THE INVENTION

Personal vehicles, including light trucks, are perceived by their owners as an expression of the owner's personality and individuality. Accordingly, it is popular to modify and accessorize such vehicles. One popular form of accessorization is with decorative lighting effects. This may include illuminated license plate frames, and neon lights beneath the vehicle to illuminate the roadway below. While such lights may be of a range of selected colors, they are still of limited individuality, as they do not provide a specific expression of the owner.

Decorative vehicle lights have been provided to display a message or text. For instance, US Pat. No. 6,604,834 to Kalana shows a truck with flat running boards with illuminated text on the upper surface, visible from above by someone standing next to or while entering or exiting the vehicle. However, this is a limited color, and an unchangeable single text or graphic message backlit by a single color. In addition, the planar illumination source limits the shape to a flat panel, unlike the more rugged tubular members preferred by many truck owners.

### SUMMARY OF THE INVENTION

The present invention overcomes the limitations of the prior art by providing a vehicle light for connection beneath a doorway of the vehicle. The light has an elongated housing element with an aperture facing laterally away from the vehicle. A light source is contained within the housing. A light-transmissive image element is removably connected to the housing to overlay the aperture. The housing may be tubular, with a circular cross section, and the light source may be a linear element centered in the tube. The light source may be a broad band emitter, so that a multicolor image element may be illuminated.

### BRIEF DESCRIPTION OF THE DRAWINGS

FIG. 1 is a side view of a truck having a step bar light according to a preferred embodiment of the invention.

FIG. 2 is an exploded view of the light of FIG. 1.

FIG. 3 is a cross sectional end view of the preferred embodiment of the invention.

### DETAILED DESCRIPTION OF A PREFERRED EMBODIMENT

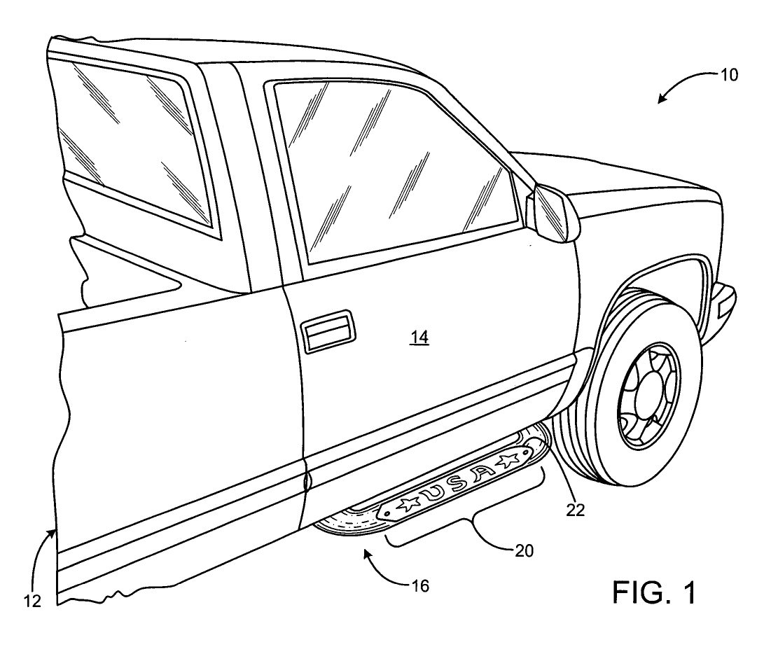

FIG. 1 shows a truck 10 having a body 12 and door 14. A tubular step bar 16 is counted to the lower portion of the truck body or frame below the door 14. The step bar 16 is a tubular form with a circular cross section, a straight main portion 20 between curved end portions that form 90 degree elbows, with free ends extending under the truck for connection to the truck frame. With the straight and end portions, the housing defines a horizontal plane. An elongated image film and lens 22 is positioned on the housing to face laterally away from the center of the truck. In alternative embodiments, the lighting features described in the context of a step bar may be employed for roll bars, bumpers, and other bars and tubular elements employed on a vehicle for decorative, structural, or protective purposes.

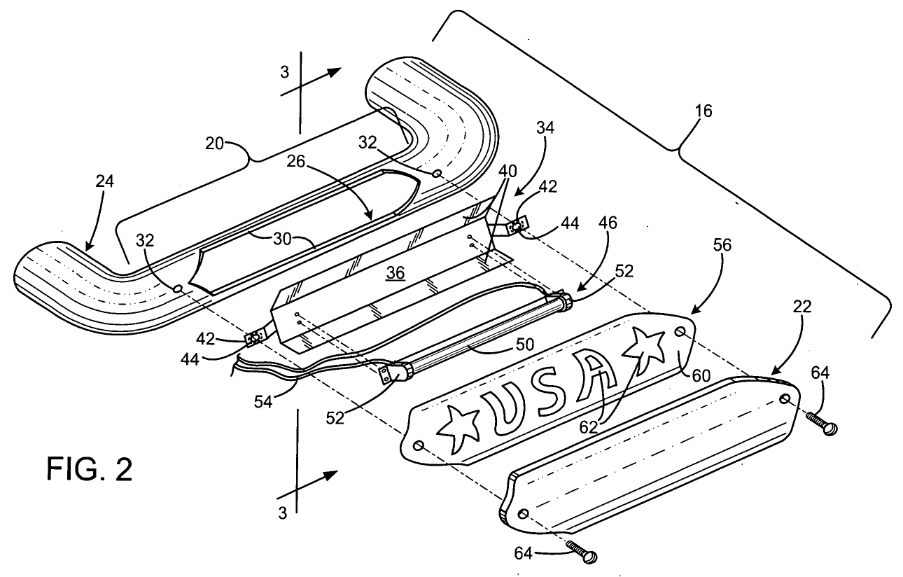

FIG. 2 shows an exploded view of the step bar lighting assembly 16. A housing 24 is a cylindrical steel tube bent to the illustrated shape. The wall of the tube at the straight central portion 20 has an elongated aperture 26 that is cut into the tube over a major portion of the length of the straight portion. The aperture has a six-sided oblong shape, with opposed elongated major side edges 30, and with the ends of the aperture formed by V-shaped cuts in the tapered manner of an arrowhead shape. In an alternative embodiment, the aperture ends may be rounded or squared off. A pair of threaded holes 32 is defined just beyond the ends of the apertures at the points of the ends of the aperture. In the preferred embodiment, the housing is formed of carbon or stainless steel, with a wall thickness of 0.090 inches. The overall length of the housing is 18 inches, which may range over a wide range of sized for different applications. The tube has a diameter of 3 inches, and the aperture has a length of 17 inches, and a width (the distance between edges 30 as measured circumferentially around the tube curve) of up to 2.75 inches, which may also vary in alternative embodiments. The holes 32 are sized to provide clearance for the fasteners to be discussed below.

A reflector bracket 34 is an elongated body sized to fit within the tube and be inserted via the aperture. The bracket includes a reflector panel having a back portion 36 and upturned side portions 40 that are angled laterally away from the truck, when installed to reflect light out of the aperture from the light source discussed below. The reflector is formed of a lightweight reflective material, which may be white plastic or painted metal, or plated or polished plastic or metal. The bracket includes attachment arms 42 at each end. The arms have end portions that are positioned in a plane lateral to the back panel of the reflector, forward of the side panel edges. Although not shown for clarity, the rear faces of the attachment arms include resilient supports such as foam blacks or springs that provide compression to the rear, for biasing the fronts of the arms against the inner surface of the tube as will be discussed below. This retains the bracket in place when the film is changed. The arms define holes 44, and have attached nuts such at “PEM nuts” on the back or medial side to receive a threaded fastener. The holes 44 are spaced to register with the housing. holes 32.

A light source 46 includes a cold-cathode fluorescent tube 50, and end connector elements 52 supporting and powering the tube, and which are to be secured to the reflector bracket. A driver unit or ballast (not shown) is required to power the tubes, and may be mounted on the rear of the reflector, in the housing beyond the length of the reflector, or on the vehicle. Power wires 54 extend from the connector elements, and extend to power and control circuitry (not shown) in the truck. The light tube 50 extends nearly the length of the aperture 26. In alternative embodiments, the light source may be any linear, elongated source including a linear array or arrays of LEDs or other point source lamps (including rope lighting), a set of shorter end-to-end tubes, and a pair of full length side-by-side tubes. In other alternatives, the light source may be an extended or diffuse source such as an electroluminescent display sheet or wire. The light source is a broad band source, preferably emitting white light, so that a filter of any or multiple colors may be placed over it and illuminated. In alternative embodiment employing narrow band sources such as colored LEDs, several different light source colors should be employed to provide the effect of a broad band source.

A image film 56 is a flexible light transmissive sheet, preferably having a diffuse translucent quality. The sheet has an image imprinted on it, and the image may include black or opaque portions 60, and transmissive portions 62. The transmissive portions may be of any color, and the color and density may vary, in the manner of a photographic transparency. The image may include multiple color portions, and may include graphic or text elements. The film is preferably a plastic sheet on which the image has been generated by any suitable printing, photographic, or screening process. The image may have any image qualities available to transparencies, including color gradients, dot half tones, solid portions, applied pigment, pigment in the material of the sheet, photographic images, and the like. The film is shaped and sized to fully cover the housing aperture 26 when curved to conform to the housing radius along its length and at both ends. The film defines apertures at the ends to register with the bracket and housing holes.

The lens 22 is a rigid element having the same profile as the image film 56, including end apertures. The lens is formed of smoked transparent acrylic or other thermoplastic, with a thickness of 1/16^{th} to ¼^{th} inch to provide rigidity. In alternative embodiments, the lens may be clear, or include some diffusion such as on the inner surface against the image film. The lens may be molded, or may be cut from tubing that has an interior curvature that matches the exterior curvature of the housing tube. In an alternative embodiment, the lens may be located within the housing tube. A pair of machine screws 64 are selected to pass through the holes in the lens, film, and housing, and to threadably engage the nuts on the bracket, so that tightening the screws compresses the lens against the housing from the exterior, and compresses the bracket ends against the housing interior.

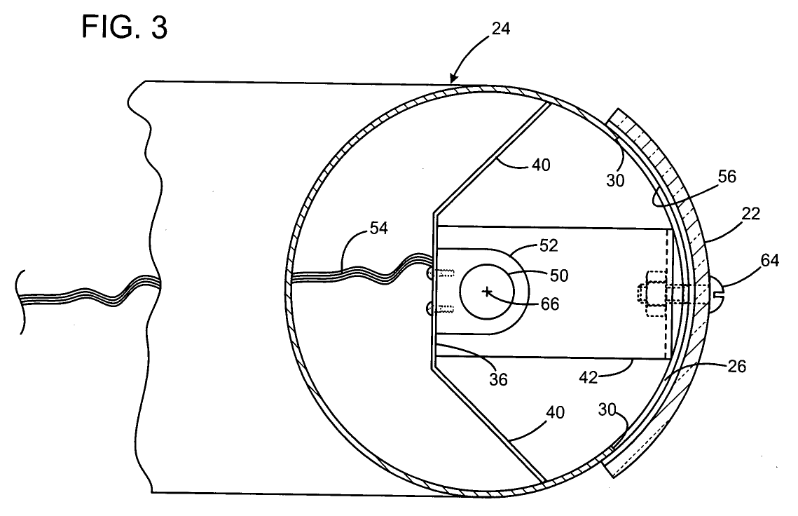

FIG. 3 is a cross sectional view taken along line 3-3 of FIG. 2, through the central straight portion and light tube. The figure illustrates how the light tube 50 is aligned with the central axis 66 of the housing tube. In alternative embodiments, the lamp may be positioned closer to the image film, and a pair of lamps may be employed to prove broader distribution of the light. The lens 22 is shown overlaying and capturing the film 56 to overlap the housing at near the edges 30. The lamp wires 54 extend through the housing to the end of the housing. In the preferred embodiment, the lamps are selected to run on 12V DC voltage available from the vehicle, In other embodiments, a suitable transformer may be provided within on the vehicle, or within the volume of the step bar, such as by attachment to the rear of the reflector element.

In the preferred embodiment, the housing aperture 26 is oriented laterally to the truck (so that the top and bottom edges 30 are oriented at equal or similar angles above horizontal plane when measured using the housing axis 66 as a reference.) Because the displayed image is intended to be viewed by other vehicles and pedestrians, the lateral orientation is necessary. However, because the eye level of such viewers is expected to be above the level of the image as mounted on a vehicle, the horizontal centerline of the aperture may be positioned somewhat above a lateral position, while portions of the aperture remain at the lateral position.

While the disclosure is made in terms of a preferred embodiment, the invention is not intended to be so limited. For instance, the image may employ advanced electronic display technology that allows the image to be changed during operation. A curved or flexible LCD film would allow this capability.

1. A vehicle light for connection to a vehicle comprising:
an elongated housing element;
the housing element defining an aperture facing laterally away from the vehicle;
a light source within the housing; and
a light-transmissive image element removably connected to the housing to overlay the aperture.

2. The light of claim 1 wherein the housing element is a tubular element with a circular cross section.

3. The light of claim 1 wherein the housing element is a step bar.

4. The light of claim 1 wherein the light source is an elongated source.

5. The light of claim 4 wherein the light source is a straight, linear tube.

6. The light of claim 4 wherein the light source is generally coincident with a central axis defined by the housing.

7. The light of claim 1 wherein the aperture has an oblong shape having opposed major edges running parallel to an axis defined by the housing element.

8. The light of claim 1 wherein the image element includes a flexible film containing the image, and a light transmissive lens element overlaying the film.

9. The light of claim 1 wherein the image element has a shape that conforms to the shape of the housing such that the image element encloses the aperture.

10. The light of claim 1 wherein the image element includes a plurality of colors.

11. The light of claim 1 where in the light source is a broad-band light source emitting a wide range of wavelengths such that it may illuminate a multicolor image element.

12. A tubular step bar for connection to a vehicle comprising:
a tubular housing element having a generally circular cross section;
a light source within the housing element;
the housing element defining an elongated aperture registered with the light source;
a light-transmissive image element overlaying the aperture; and
the image element having a curved form to conform to the shape of the tubular housing and to enclose the aperture.

13. The step bar of claim 12 wherein the image element is removable such that the image may be changed.

14. The step bar of claim 12 wherein the light source is generally coincident with a central axis defined by the housing.

15. The step bar of claim 12 wherein the aperture has an oblong shape having opposed major edges running parallel to an axis defined by the housing element.

16. The step bar of claim 12 wherein the image element includes a flexible film containing the image, and a light transmissive lens element overlaying the film.

17. A vehicle having a door comprising:
a vehicle frame;
an elongated step element connected to a lower portion of the frame below a door;
the elongated step element defining an elongated chamber;
an elongated linear light source within the chamber; and
the step element including a light-transmissive image portion adjacent to the light source.

18. The vehicle of claim 17 wherein the light source is generally coincident with a central axis defined by the housing.

19. The vehicle of claim 17 wherein the image element has a cylindrical shape centered on an axis defined by the light source.

20. The vehicle of claiim 17 wherein the light source is a broad-band light source emitting a wide range of wavelengths such that it may illuminate a multicolor image element.
